(19) United States
(12) Patent Application Publication
(10) Pub. No.: US 2004/0158642 A1
(43) Pub. Date: Aug. 12, 2004

(54) Method and system for transmitting data flow between two remote stations

(76) Inventors: Pierre Thorel, St. Martin D'Uriage (FR); Franck Pellissier, Crolles (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/471,160

(22) PCT Filed: Mar. 7, 2002
(86) PCT No.: PCT/FR02/00819

(30) Foreign Application Priority Data
Mar. 8, 2001 (FR) 01/03127

(51) Int. Cl. G06F 15/16

(52) U.S. Cl. 709/231

(57) ABSTRACT

The invention relates to a system for transmitting data streams between two remote stations (1; 2) interconnected by a telecommunications network. According to the invention, each station is each station is fitted with an identical communications module (10; 20) suitable for:

firstly in processing each of said data streams received from one of said stations (1) in accordance with a single communications protocol common to all of the data streams, in which the data is organized in data packets built up in a format comprising, at least: a stream identity field (Idp); a priority field (P) for a priority allocated to said stream; and a data field proper (DATA); and in transmitting said data packets to the other one (2) of said stations via the telecommunications network as a function of their respective priorities; and

secondly in processing each data packet received from the other one (2) of said stations as a function of the priority recorded in said priority field (P) of said packet, and in supplying said station (1) with the identity of the corresponding stream as recorded in said identity field (Idp) together with the data contained in said data field (DATA).

The invention is applicable to remote expertise, and in particular to remote echography.

The present invention relates to a method and to a system for transmitting data streams between two remote stations interconnected by a telecommunications network.

An advantageous application lies in the general field of remote presence, and in particular remote expertise, and more specifically in fields requiring actions to be performed from a distance such as remote echography or remote surgery. Other applications can also be envisaged such as networked games, and all fields in which remote manipulation is required.

The techniques relating to remote expertise, such as remote echography, generally make use of two stations that are remote from each other, namely a master station or expert station which, in the example of remote echography, is the station where the doctor or midwife is present, and a slave station or patient station which is the station where the pregnant woman is to be examined. The two stations are interconnected by a telecommunications network which may be an integrated systems digital network (ISDN), an Internet protocol (IP) network, etc.

The exchange of information between two remote stations of the above type requires several complex data streams to be transmitted from one station to the other, which streams need to be processed in application of differing specific constraints. Mention can be made of the following, for example:

The both-way video data stream or video channel which conveys images of the expert and of the patient, together with their respective environments. These images must be of good quality. It is therefore necessary to establish a compromise between bit rates, number of images per second, definition, and image size so as to enable the expert to have a good view of the scene and so as to enable good visual communication between the expert and the patient, which is essential in establishing a climate of confidence in the face of this new type of communication.

The both-way audio data stream or audio channel, which conveys speech and sounds coming from the stations between the expert and the patient. In order to obtain good sound quality, it is necessary to use an appropriate bit rate and encoding, and also to have transmitters and receivers that are suitable for ensuring that the participants can listen and speak comfortably from the positions they happen to be in. This sound quality also contributes to a climate of confidence.

The echography data stream, or echography channel, which transmits to the expert station images picked up by an echographic probe being moved over the patient's abdomen. The same compromise as for the video channel is needed, but nevertheless the constraints are different as a function of the stage in the procedure. It is thus possible to distinguish between two modes of operation:

an exploratory stage which may contain images at low definition but which requires a large number of images per second due to the speed at which the probe is moved, associated with minimum encoding and transport delays;

the pickup stage or advanced exploration stage in which a small number of images per second suffices insofar as the echographic probe is stationary or moving slowly. However, high definition images and longer encoding and transport delays are needed.

The haptic data stream or haptic channel conveying firstly commands to the echographic probe issued by the expert station and secondly force-return information transmitted by the probe to the expert during remote manipulation. The constraints on this channel are total time delay from one end of the system to the other which should ideally be less than 10 milliseconds (ms), jitter, and the way information is arranged. It should be observed that with a synchronous network of the ISDN type, the arrangement is resolved, jitter is minimized, and delays are short.

The control data stream, or control channel. This channel must always be available, but it does not present any special constraints. In general terms it relates to initializations, adjustments, and changes of state in the videophone (video and audio), echography, and haptic streams.

In spite of the constraints imposed on them, it is essential for all of the streams to be processed with great precision in order to ensure that an examination performed under remote echography provides results that are as reliable as possible.

It is necessary to enable the remote expert to control the displacement of the echographic probe under the best possible conditions. Throughout the examination, the expert must have a complete view of the entire scene in real time, must dialog with the patient and with the carers present, monitor the echography acquisition parameters, view the echographic images, and specify the directions of the displacements desired of the real probe by moving a virtual probe held in the hand.

In addition, on the basis of the quality of the echographic images, the expert must check that the displacement instructions are carried out properly and possibly modify the way instructions are being given in the light of force-return information received from the virtual probe concerning the pressure being exerted by the real probe.

At the other end, the patient or the staff present with the patient must be able to initialize the position of the system for displacing the echographic probe, converse with the expert situated at the other station, interrupt displacement of the probe and return control to the expert after such an interruption, possibly moving the probe manually in response to voice instructions from the expert in order to deal with situations in which the system becomes blocked.

Thus, the technical problem to be solved by the present invention is that of proposing a method of transmitting data streams between two remote stations that are interconnected via a telecommunications network, the method enabling a set of different data streams to be processed in uniform manner while nevertheless complying with the specific constraints associated with each of said streams, and in particular the haptic data stream.

According to the present invention, the solution to the technical problem posed consists in that said method comprises the steps consisting in:

firstly in processing each of said data streams received from one of said stations in accordance with a single communications protocol common to all of the data streams, in which the data is organized in data packets built up in a format comprising, at least: a stream identity field; a priority field for a priority allocated to said stream; and a data field proper; and in transmitting said data packets to the other one of said stations via the telecommunications network as a function of their respective priorities; and

secondly in processing each data packet received from the other one of said stations as a function of the priority recorded in said priority field of said packet, and in supplying said station with the identity of the corresponding stream as recorded in said identity field together with the data contained in said data field.

Similarly, in the invention, a system for transmitting data streams between two remote stations interconnected by a telecommunications network is remarkable in that each station is fitted with an identical communications module adapted:

firstly to process each of said data streams received from the associated station in accordance with a single communications protocol common to all of the data streams, in which the data is organized in data packets built up in a format comprising, at least: a stream identity field; a priority field for a priority allocated to said stream; and a data field proper; and to transmit said data packets to the communications module of the other one of said stations via the telecommunications network as a function of their respective priorities; and

secondly to process each data packet received from the communications module of the other one of said stations as a function of the priority recorded in said priority field of said packet, and to supply the associated station with the identity of the corresponding stream as recorded in said identity field together with the data contained in said data field.

As explained in detail below, the invention achieves a certain number of objectives, and in particular:

Minimum transfer delay for transmission over the haptic channel. Given the intrinsic delay times of a few milliseconds for switching a time slot over the public switched telephone network (PSTN), the major portion of transmission delay can be attributed to the terminals. By minimizing the complexity of the software in the communications system, while keeping a solution that is standard and widely available across the country, the invention makes it possible to obtain end-to-end transfer time values that come close to about 10 ms. Naturally, as already mentioned above, by its very nature, use of an ISDN provides guarantees concerning the time taken to convey data, concerning jitter, and concerning delays in the arrangement of information.

Modular architecture, making management of the data streams independent from the communications medium used, and making it possible, at will, to add or to remove certain streams.

The data streams are formatted using a specific communications protocol.

Priorities between the various data streams to be transmitted are managed.

The following description with reference to the accompanying drawings given as non-limiting examples shows clearly what the invention consists in and how it can be implemented.

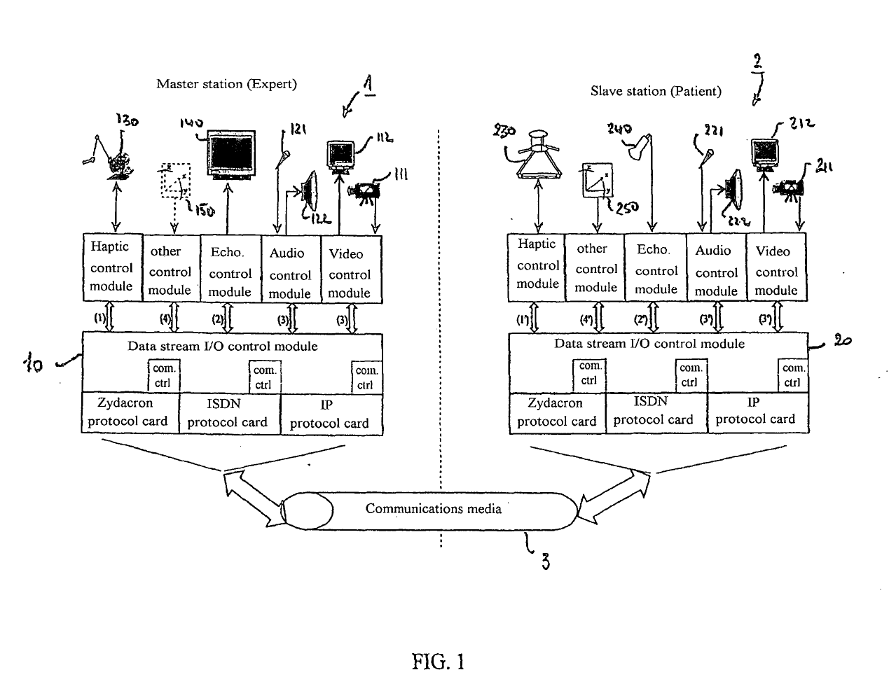

FIG. 1 is a diagram showing the general architecture of the data transmission system in accordance with the invention.

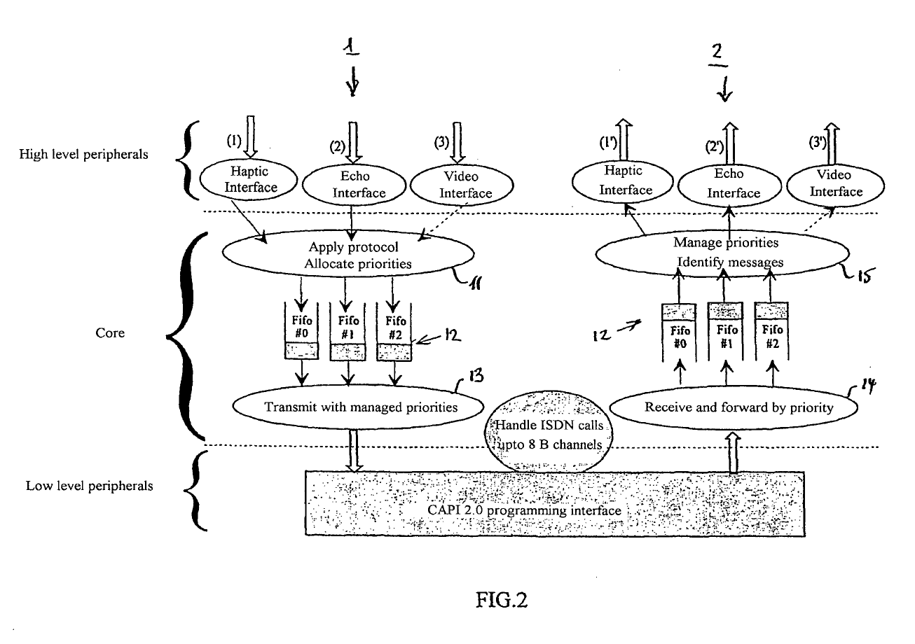

FIG. 2 is a diagram showing the architecture of a communications module in the system of FIG. 1.

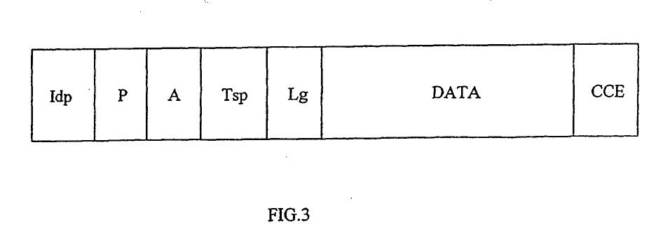

FIG. 3 is a diagram showing a data packet format in a communications protocol used in the FIG. 1 system.

FIG. 1 shows a system for transmitting streams of data between two remote stations 1 and 2 interconnected by a telecommunications network 3 such as an ISDN, an IP network, etc.

The description below relates to the particular example of a system for remote echography between the station 1 of an expert, generally a doctor, and the station 2 of a patient accompanied by specialist personnel.

These stations 1 and 2 are fitted in such a manner as to be capable of exchanging a variety of data streams enabling a remote echography examination to be performed under the best possible conditions.

In particular, there is a set of videophone data streams (3), (3′) enabling each station to receive images and sound picked up in the environment of the other station. These streams enable the doctor and the patient to see each other and to speak together, in the context of a climate of confidence as mentioned above. For this purpose, cameras 111, 211, TV monitors 112, 212, microphones 121, 221, and loudspeakers 122, 222 are installed at the stations 1 and 2 respectively.

The haptic data streams (1), (1′) are exchanged between a virtual probe 130 handled by the doctor on the expert station 1 and a robot 230 carrying the echographic probe 240, both being situated at the patient station 2. Said robot 230 remotely reproduces the movements of the probe 130 corresponding to the displacements that the doctor seeks to apply to the echographic probe 240. Furthermore, the robot 230 transmits to the virtual probe 130 the pressure forces exerted by the patient's abdomen on the probe 240 during examination. This type of force-return information is essential for the doctor since it enables the doctor to identify accurately the location on the abdomen where the echographic probe 240 is situated and thus enables the doctor to move the probe with knowledge.

The echography data streams (2), (2′) concern transmitting the images supplied by the probe 240 from the patient station 2 to a TV monitor 140 at the expert station 1.

As shown in FIG. 1, each station 1, 2 is fitted with an identical communications module 10, 20 suitable for processing the various data streams coming from the associated station or the remote station, and taking the best possible account of the constraints imposed on these various streams. For this purpose, the data streams received from the associated station are processed in application of a single communications protocol common to all of the types of stream, and in which data is organized in one format, with one particular example of its streams being shown in FIG. 3.

The fields shown in the figure are, in order, as follows:

Idp which is an identifier of the stream being transmitted, i.e. videophone, haptic, or echographic. By way of example, this field is 8 bits long;

P which is a priority indicator, this field is 2 bits long and can take the values 0 for high priority, 1 for medium priority, and 2 for lower priority;

A is an optional field requesting message acknowledgment by low level peripherals, if A=1 acknowledgment is required, else A=0;

Tsp is information concerning machine time at the instant of transmission, having a typical length of 12 bits, this field is used for synchronizing the streams;

Lg is the length of the DATA field in 8-bit bytes, the length of this field is about 16 bits;

DATA which contains the data to be transmitted, its length is the value given in the field Lg; and

CCE which is the error check code, this optional field serves to make data transport more secure.

An embodiment of a communications module 10 is described below with reference to FIG. 2.

The module of FIG. 2 comprises a formatting submodule 11 which operates in real time to read the data in the various streams received from the associated station 1 via high level peripherals. As a function of these streams, the submodule 11 makes up data packets in the format of the FIG. 3 communications protocol and provides the information in the identity field Idp, the priority field P, the acknowledgment field A, the length field Lg, and the data field DATA.

The data packets are then distributed in a queuing submodule 12 which is based on the first-in-first-out (FIFO) type queues, each queue being associated with a particular level in the priority field P. In the example shown, three queues are defined: FIFO#0, FIFO#1, and FIFO#2 corresponding respectively to priority levels that are high, medium, and low.

A transmission submodule 13 reads the transmission queues in the submodule 12 in real time and transmits data packets over the telecommunications network in priority order by initially emptying the queue FIFO#0, then the queue FIFO#1, and finally the queue FIFO#2. In order to ensure that the transmission channel is not monopolized by a single priority level, values are defined for maximum numbers of consecutive reads per type of queue. The field Tsp is filled in at this moment.

When a data packet is received from the telecommunications network, it is taken up by a reception submodule 14 which reads the priority field P of the packet and places it in the appropriate queue in the queuing submodule 12.

Finally, an identification submodule 15 acts in real time to read the reception queues in priority order, successively emptying the queues FIFO#0, FIFO#1, and FIFO#2. In this case also, maximum values are defined for numbers of consecutive reads per type of queue in order to avoid the transmission channel being monopolized by a single priority level. The contents of the fields Idp, A, and DATA are extracted from the packets, the data from the DATA field being delivered to the associated receive station via high level peripherals identified by the identity field Idp. Optionally, if the value of the acknowledgment field A is equal to 1, an acknowledgment is established and put into a transmission queue.

1/ A method of transmitting various data streams between two remote stations (1; 2) interconnected by a telecommunications network, the method being characterized in that it comprises the steps consisting:
firstly in processing each of said data streams received from one of said stations (1) in accordance with a single communications protocol common to all of the data streams, in which the data is organized in data packets built up in a format comprising, at least: a stream identity field (Idp); a priority field (P) for a priority allocated to said stream; and a data field proper (DATA); and in transmitting said data packets to the other one (2) of said stations via the telecommunications network as a function of their respective priorities; and
secondly in processing each data packet received from the other one (2) of said stations as a function of the priority recorded in said priority field (P) of said packet, and in supplying said station (1) with the identity of the corresponding stream as recorded in said identity field (Idp) together with the data contained in said data field (DATA).

2/ A system for transmitting various data streams between two remote stations (1; 2) interconnected by a telecommunications network, the system being characterized in that each station is fitted with an identical communications module (10; 20) adapted:
firstly to process each of said data streams received from the associated station (1; 2) in accordance with a single communications protocol common to all of the data streams, in which the data is organized in data packets built up in a format comprising, at least: a stream identity field (Idp); a priority field (P) for a priority allocated to said stream; and a data field proper (DATA); and to transmit said data packets to the communications module (20; 10) of the other one (2; 1) of said stations via the telecommunications network as a function of their respective priorities; and
secondly to process each data packet received from the communications module (20; 10) of the other one (2;
1) of said stations as a function of the priority recorded in said priority field (P) of said packet, and to supply to the associated station (1; 2) with the identity of the corresponding stream as recorded in said identity field (Idp) together with the data contained in said data field (DATA).

3/ A communications module for fitting to remote stations (1; 2) interconnected by a telecommunications network in a system for transmitting various data streams between said remote stations, said communications module (10; 20) being characterized in that it is adapted:
firstly to process each of said data streams received from the associated station (1; 2) in accordance with a single communications protocol common to all of the data streams, in which the data is organized in data packets built up in a format comprising, at least: a stream identity field (Idp); a priority field (P) for a priority allocated to said stream; and a data field proper (DATA); and to transmit said data packets to the communications module (20; 10) of the other one (2; 1) of said stations via the telecommunications network as a function of their respective priorities; and
secondly to process each data packet received from the communications module (20; 10) of the other one (2) of said stations as a function of the priority recorded in said priority field (P) of said packet, and to supply the associated station (1) with the identity of the corresponding stream as recorded in said identity field (Idp) together with the data contained in said data field (DATA).

4/ A communications module according to claim 3, characterized in that said communication module (10) comprises:
firstly:
a formatting submodule (11) suitable for making up said data packets and filling in the stream identity field (Idp), the priority field (P), and the data field (DATA) in the format of said communications protocol as a function of the streams received from the associated station (1);
a queuing submodule (12) comprising queues each associated with a respective priority in the priority field (P) and suitable for distributing said data packets in said queues as a function of their respective priorities; and
a transmission submodule (13) suitable for transmitting the data packets to the communications module (20) of the other station (2) by emptying said queues as a function of their priorities;
and secondly:
a reception submodule (14) suitable for receiving the data packets received from the communications module (20) of the other station (2) and for forwarding them to said queuing submodule (12); and
an identifying submodule (15) suitable for emptying the queues as a function of their priorities, for extracting the stream identity field (Idp) from the data packets, and for delivering the data contained in said data field (DATA) together with its identification to the associated station (1).
